(19) United States
(12) Patent Application Publication
(10) Pub. No.: US 2009/0042016 A1
(43) Pub. Date: Feb. 12, 2009

(54) White polyester film

(75) Inventors: Tatsuo Yoshida, Gifu (JP); Takashi Ueda, Mishima-shi (JP); Taichi Miyazaki, Gifu (JP)

Correspondence Address: BIRCH STEWART KOLASCH & BIRCH, PO BOX 747, FALLS CHURCH, VA, 22040-0747, US

(73) Assignee: TORAY INDUSTRIES, INC.

(21) Appl. No.: 12/219,111

(22) Filed: Jul. 16, 2008

(30) Foreign Application Priority Data
Jul. 19, 2007 (JP) 2007-187965

(51) Int. Cl. B32B 3/26

(52) U.S. Cl. 428/317.9

(57) ABSTRACT

The object of the present invention is to provide a white polyester film which achieves a high reflectivity and a high hiding property, and has high productivity. A white polyester film, wherein the white polyester film has a layer (layer B) containing voids therein, and contains amorphous cyclic olefin copolymerized resin incompatible with polyester in an amount of 3 to 15% by weight, a block copolymer resin of polyalkylene glycol and a polyester resin formed from an aliphatic diol component having 2 to 6 carbon atoms and terephthalic acid in an amount of 2 to 10% by weight, and inorganic particles in an amount of 5 to 25% by weight relative to the total amounts of constituents in the layer B, and wherein the average particle sizes on number in the layer B are 0.4 to 3 μm, and the maximum particle sizes thereof are not more than 5 μm.

### TECHNICAL FIELD

The present invention relates to a white polyester film. More particularly, the present invention relates to a white polyester film which contains voids therein, has an excellent reflection property and an excellent hiding property, and has high productivity, and which can be suitably used for a backlight system for image display, a reflection sheet of a lamp reflector, a reflection sheet of lighting equipment, a reflection sheet for an illuminated signboard, a back-reflection sheet for a solar cell, and the like.

### BACKGROUND ART

White polyester films are widely used for applications such as a reflector and a reflection sheet of a surface illuminant apparatus in a flat-panel image display system used for liquid crystal display or the like, a rear-reflection sheet for an illuminated signboard and a back-reflection sheet for a solar cell because of characteristics that these film have uniform and high brightness and dimensional stability, and are low priced. As a method of exhibiting high brightness, there are widely employed methods of utilizing a difference in refractive indexes between an inorganic particle contained in a polyester film and a polyester resin, or a difference in refractive indexes between a minute void and a polyester resin, such as a method in which a polyester film contains a great number of inorganic particles such as barium sulfate and light reflection at an interfacial surface between a polyester resin and a particle and a void's interfacial surface of the minute void produced with a core of particles is utilized (Patent Document 1), a method in which light reflection at a void's interfacial surface of the minute void produced with a core of a resin incompatible with polyester by mixing the resin incompatible with polyester is utilized (Patent Document 2), and a method in which light reflection at an interfacial surface of the void internally produced by including inert gas in a polyester film in a pressure vessel is utilized (Patent Document 3).

In recent years, particularly, applications in which liquid crystal display is used are remarkably expanded and the liquid crystal display is widely adopted for LCD televisions in addition to conventional laptop computers, monitors, and mobile devices, and in accordance with this, higher brightness and higher definition of a screen are required. There are requirements for high brightness and a high hiding property in reflecting sheets in response to the higher brightness of the screen. In accordance with these requirements, actions of increasing a number of interfacial surfaces to reflect light in the polyester film, such as increasing an amount of inorganic particles in the polyester film and increasing an amount of a resin incompatible with polyester, are required, but there arises a problem that by increasing the amounts of inorganic particles and a resin incompatible with polyester, a film break often occurs during biaxial stretching and productivity is deteriorate, and it was difficult to achieve high brightness/high hiding property and the productivity of a film simultaneously.

Further, on the other hand, species of resin incompatible with polyester are also studied (Patent Document 4 and Patent Document 5). However, it becomes difficult to respond to the high brightness and the high hiding property in recent years by technologies described in these Patent Documents.

### Patent Document 1 Japanese Unexamined Patent Publication No. 2004-330727

### Patent Document 2 Japanese Unexamined Patent Publication No. 04-239540

Patent Document 3 International Publication WO 97/01117 pamphlet

### Patent Document 4 Japanese Unexamined Patent Publication No. 05-9319

### Patent Document 5 Japanese Unexamined Patent Publication No. 08-302048

### DISCLOSURE OF THE INVENTION

### Problems to be Solved by the Invention

In view of the problem of the art, it is an object of the present invention to provide a white polyester film which achieves high brightness and a high hiding property simultaneously, and hardly causes a film break or unevenness of brightness in a width direction, and achieves productivity and performance simultaneously.

### Means for Solving the Problems

(1) A white polyester film, wherein the white polyester film has a layer (layer B) containing voids therein, and contains amorphous cyclic olefin copolymerized resin incompatible with polyester in an amount of 3 to 15% by weight,

a block copolymer resin of polyalkylene glycol and a polyester resin formed from an aliphatic diol component having 2 to 6 carbon atoms and terephthalic acid in an amount of 2 to 10% by weight, and

inorganic particles in an amount of 5 to 25% by weight relative to the total amounts of constituents in the layer B and

wherein average particle sizes on number of the amorphous cyclic olefin copolymerized resin and the inorganic particles dispersed in the layer B are 0.4 to 3.0 μm, respectively, and the maximum particle sizes thereof are not more than 5 μm.

(2) The white polyester film according to the (1), wherein a glass transition temperature of the amorphous cyclic olefin copolymerized resin incompatible with polyester is 120° C. or higher and 230° C. or lower
(3) The white polyester film according to the (1) or (2), wherein alight reflectivity is 97% or more and a total light transmittance is less than 5%.
(4) The white polyester film according to any one of the (1) to (3), wherein a copolyester resin including alicyclic glycol is contained in the layer (layer B) containing voids therein in an amount of 1 to 10% by weight relative to constituents in the layer B.
(5) The white polyester film according to any one of the (1) to (4), wherein the amorphous cyclic olefin copolymerized resin incompatible with polyester is not substantially contained in a layer (layer A) adjacent to at least one surface of the layer (layer B) containing voids therein.
(6) The white polyester film according to any one of the (1) to (5), wherein the same inorganic particles as in the layer B are contained in the layer (layer A) adjacent to at least one surface of the layer (layer B) containing voids therein in an amount of 0.5 to 20% by weight relative to constituents in the layer A.
(7) The white polyester film for a reflection sheet according to any one of the (1) to (6), wherein light-resisting coating is applied to the surface layer of the white polyester film.
(8) The white polyester film according to any one of the (1) to (6), wherein a light-resisting agent is contained in the layer (layer A) adjacent to the layer (layer B) containing voids therein in an amount of 0.05 to 10% by weight relative to constituents in the layer A.

### EFFECTS OF THE INVENTION

In accordance with the present invention, a white polyester film which achieves high brightness and a high hiding property simultaneously and hardly causes a film break or unevenness of brightness in a width direction during production, and achieves productivity and performance simultaneously can be obtained at low cost.

### BRIEF DESCRIPTION OF THE DRAWINGS

FIG. 1 is a schematic view of a cross-section photograph of the present invention.

FIG. 2 is a view illustrating a measuring method of a particle size in the present invention.

### DESCRIPTION OF THE REFERENCE NUMERALS AND SYMBOLS

1 particle (inorganic particle, polyolefin-based resin (amorphous cyclic olefin copolymerized resin) incompatible with polyester)
2 void
3 polyester resin
4 blacked out areas of particles on an overhead projector sheet

### BEST MODE FOR CARRYING OUT THE INVENTION

The present inventors have made earnest investigations on the problems, that is, a white polyester film which achieves high brightness and a high hiding property simultaneously and hardly causes a film break during production, and has high productivity, and consequently have found that a polyester film having a specific constitution can solve such problems in one swoop.

The present invention needs to be a white polyester film, wherein the white polyester resin has a layer containing voids therein and has a layer (layer B) in which a resin composing the layer containing voids therein contains a polyester resin, amorphous cyclic olefin copolymerized resin incompatible with polyester, a block copolymer resin of polyalkylene glycol and a polyester resin formed from an aliphatic diol component having 2 to 6 carbon atoms and terephthalic acid, and inorganic particles, and wherein the average particle sizes on number of the amorphous cyclicolefin copolymerized resin and the inorganic particles are 0.4 to 3.0 μm, respectively, and the maximum particle sizes thereof are not more than 5 μm, and by employing such a constitution, it becomes possible to improve the brightness and the hiding property of a film outstandingly.

By mixing a block copolymer resin of polyalkylene glycol and a polyester resin formed from an aliphatic diol component having 2 to 6 carbon atoms and terephthalic acid with the amorphous cyclic olefin copolymerized resin to melt-extrude this mixture, and by specifying an amount of the amorphous cyclic olefin copolymerized resin to 15% by weight or less of the constituents in the layer, re-agglomeration of the amorphous cyclic olefin copolymerized resin can be prevented and minute dispersion of this resin can be realized. Further, by only using the amorphous cyclic olefin copolymerized resin incompatible with the polyester, a number of voids produced between the amorphous cyclic olefin copolymerized resin and the polyester is small and a reflection property and a hiding property are inadequate, and it is necessary to supplement these properties by adding inorganic particles.

In the present invention, a component in the void (hereinafter, sometimes referred to as a vapor phase) is generally air, the void may be under vacuum or may be filled with other gas components, and examples of other gas components include oxygen, nitrogen, hydrogen, chlorine, carbon monoxide, carbon dioxide, steam, ammonia, nitrogen monoxide, hydrogen sulfide, sulfur dioxide, methane, ethylene, benzene, methyl alcohol, ethyl alcohol, methyl ether, and ethyl ether. These gas components may exist alone or may be a mixed gas of two or more gases. Furthermore, an internal pressure of the void may be above or below an atmospheric pressure.

With respect to a polyester resin to be used for the white polyester film of the present invention, examples of constituents include the following components. Typical examples of dicarboxylic acid components include terephthalic acid, isophthalic acid, 5-sodium sulfoisophthalic acid, phthalic acid, diphenic acid and ester derivatives thereof as aromatic dicarboxylic acids; adipic acid, sebacic acid, dodecadionic acid, eicosanoic acid, dimeric acid and ester derivatives thereof as aliphatic dicarboxylic acids; 1,4-cyclohexanedicarboxylic acid and ester derivatives thereof as alicyclic dicarboxylic acids; and trimellitic acid, pyromellitic acid and ester derivatives thereof as polyfunctional acids. Representative examples of diol components include polyethers such as ethylene glycol, propanediol, butanediol, neopentyl glycol, pentanediol, hexanediol, octanediol, decanediol, cyclohexane dimethanol, diethylene glycol, triethylene glycol, polyethylene glycol, tetramethylene glycol, polyethylene glycol, and polytetramethylene glycol. Considering mechanical strength, heat resistance and production cost of a polyester film to be produced, it is preferable that the polyester resin in the present invention include polyethylene terephthalate as a basic constitution. The basic constitution in this case means that polyethylene terephthalate constitutes 50% by weight or more of a polyester resin to be contained.

In the present invention, a copolymer component may be introduced into the basic constitution of polyethylene terephthalate. It is preferable that the copolymer component of the copolyester resin to be mixed in the layer (layer B) containing voids therein be particularly a copolyester resin in which a main component of diol components is alicyclic glycol among the copolymer components because the copolyester resin serves to stabilize a dispersed state of the amorphous cyclic olefin copolymerized resin, and the content of the copolyester resin be preferably 1% by weight or more and 10% by weight or less relative to the total amounts of the constituents of the layer (layer B) containing voids, and more preferably 1% by weight or more and 6% by weight or less. As a method for introducing a copolymer component, a method in which a copolymer component is added during polymerizing polyester pellets or a raw material to form pellets in which the copolymer component is polymerized in advance may be employed, or a method in which, for example, a mixture of pellets polymerized singly like polybutylene terephthalate and polyethylene terephthalate pellets is supplied to an extruder and the mixture is copolymerized through a transesterification reaction during being melted may be employed. Amounts of these copolymer components are not particularly limited, but in terms of each property, an amount of each of a dicarboxylic acid component and a diol component is preferably 1 to 50 mol % relative to each component, and more preferably 1 to 20 mol %.

Examples of a catalyst to be used for a polycondensation reaction of the polyester resin preferably include antimony compounds, titanium compounds, germanium compounds and manganese compounds. These catalysts may be used alone or in combination. Among these catalysts, titanium compounds and germanium compounds are preferable in that these catalysts hardly produce metal catalyst agglomerates absorbing light, and titanium compounds are preferable from the viewpoint of cost. As titanium compounds, specifically, titanium alkoxide such as titanium tetrabutoxide and titanium tetraisopropoxide, complex oxides in which a predominant metal element comprises titanium and silicon such as titanium dioxide-silicon dioxide complex oxide, and titanium complexes can be used. Ultra-fine particle titanium oxide such as titanium-silicon complex oxide (trade name: C-94) produced by Acordis BV can also be used.

To these polyester resins, various additives, for example, fluorescent brighteners, crosslinking agents, heat stabilizers, antioxidants, ultraviolet absorbers, organic lubricants, inorganic particles, fillers, light-resisting agents, antistatic agents, nucleating agents, dyes, dispersants, and coupling agents may be added within the range of not impairing the effects of the present invention.

As the amorphous cyclic olefin copolymerized resin incompatible with polyester in the present invention, resins formed by copolymerizing amorphous cyclic olefin resins such as bicyclo[2,2,1]hept-2-ene, 6-methylbicyclo[2,2,1]hept-2-ene, 5,6-dimethylbicyclo[2,2,1]hept-2-ene, 1-methylbicyclo[2,2,1]hept-2-ene, 6-ethylbicyclo[2,2,1]hept-2-ene, 6-n-butylbicyclo[2,2,1]hept-2-ene, 6-i-butylbicyclo[2,2,1]hept-2-ene, 7-methylbicyclo[2,2,1]hept-2-ene, tricyclo[4,3,0,1^{2.5}]-3-decene, 2-methyl-tricyclo[4,3,0,1^{2.5}]-3-decene, 5-methyl-tricyclo[4,3,0,1^{2.5}]-3-decene, tricyclo[4,4,0,1^{2.5}]-3-decene and 10-methyl-tricyclo[4,4,0,1^{2.5}]-3-decene with ethylene are suitably used. Particularly, a resin which has a large difference in surface tension between this resin and polyester, and resists deformation due to a heat treatment after stretching is preferable, and among them, a copolymer of ethylene and bicycloalkene is particularly preferable. An added amount of the amorphous cyclic olefin copolymerized resin is preferably 3% by weight or more and 15% by weight or less, and more preferably 4% by weight or more and 12% by weight or less relative to the total amounts of the constituents in the layer (layer B) containing voids. If the amount is less than this range, it is not preferable because an effect of whitening degrades and a high reflection property cannot be achieved. Further, if the amount is more than this range, it is not preferable because mechanical properties such as strength of the film itself are deteriorated and agglomeration of amorphous cyclic olefin copolymerized resin tends to occur.

Amorphous cyclic olefin copolymerized resin to be used in the present invention can be produced by a publicly known liquid phase polymerization method. For example, a cyclic olefin copolymerized resin can be produced according to a method exemplified in Japanese Unexamined Patent Publication No. 61-271308. A glass transition temperature (hereinafter, sometimes referred to as “Tg”) of the cyclic olefin copolymerized resin which is obtained by these techniques and used in the present invention is preferably 120° C. or higher and 230° C. or lower. If the glass transition temperature of the cyclic olefin copolymerized resin is less than 120° C., it is not preferable because when a film is stretched, the cyclic olefin copolymerized resin deforms plastically to impair the production of voids. Further, if the glass transition temperature of the cyclic olefin copolymerized resin is more than 230° C., dispersion of the cyclic olefin copolymerized resin in case of melt-kneading the polyester resin and the cyclic olefin copolymerized resin to extrude the mixed resin into sheet with an extruder is insufficient and it becomes difficult to achieve the average particle size on number and the maximum particle size of a resin, as described below. The glass transition temperature of the cyclic olefin copolymerized resin is furthermore preferably 160° C. or higher and 200° C. or lower. The glass transition temperature can be adjusted by changing of a proportion of copolymerized of the cyclic olefin copolymerized resin. The glass transition temperature is a midpoint glass transition temperature (Tmg) of JIS K 7121 (1987) measured at a rate of temperature rise of 20° C./min with a differential scanning calorimeter.

Furthermore, since a dispersion state of the cyclic olefin copolymerized resin changes based on a balance between the viscosity of the cyclic olefin copolymerized resin and the melt viscosity of a crystalline polyester resin at a temperature at the time of melt-extruding a resin composition, the cyclic olefin copolymerized resin is preferably a resin having proper viscosity and an MVR at 260° C. is preferably 1 to 15 ml/10 min. Furthermore preferably, the MVR is 2 to 10 ml/10 min. If the MVR is more than 15 ml/10 min, it is not preferable since the resin itself may become unstable. Further, if the MVR at 260° C. is less than 1 ml/10 min, a constraint that load is placed on a filter in melt-kneading the polyester resin and the cyclic olefin copolymerized resin to extrude the kneaded resin and therefore a discharge rate cannot be increased to a preferable level may arise, or the dispersibility of the cyclic olefin copolymerized resin may be deteriorated. The MVR can be controlled by changing a reaction time, a reaction temperature, a quantity or species of a polymerization catalyst.

In the white polyester film of the present invention, it is necessary that the amorphous cyclic olefin copolymerized resin incompatible with polyester be dispersed in a matrix including a polyester resin as particles having an average particle size on number of 0.4 to 3.0 μm, preferably 0.5 to 1.5 μm. If the average particle size on number of the amorphous cyclic olefin copolymerized resin is less than 0.4 μm, a void thickness in a direction of a film thickness, even if voids are produced in a film, is smaller than a wavelength of visible light, and therefore the reflectivity of the interfacial surface to reflect the visible light is deteriorated and high brightness and a high hiding property cannot be achieved. On the other hand, if the average particle size on number is more than 3 μm or the maximum particle size is more than 5 μm, not only the film becomes vulnerable to breaks in stretching by the reduction in film strength, but also the number of interfacial surfaces in a direction of a film thickness is deficient, and therefore high brightness and a high hiding property cannot be achieved. The average particle size on number and the maximum particle size are a mean value and a maximum value of diameters of perfect circles obtained in the case where a cross section of a film is sliced off and particles in this cross section are observed with a SEM-XMA to determine areas of 100 particles and these particles are converted to perfect circles having the same area.

Further, in order to minutely disperse the amorphous cyclic olefin copolymerized resin incompatible with polyester into a preferable shape, it is necessary to add the block copolymer resin of polyalkylene glycol and a polyester resin formed from an aliphatic diol component having 2 to 6 carbon atoms and terephthalic acid. Among them, a block copolymer of polyalkylene glycol and polybutyleneterephthalate is particularly preferable. Such a resin may be used as polyester formed by copolymerizing the resin previously in a polymerization reaction or may be used as-is. An added amount of the block copolymer is preferably 2 to 10% by weight, and more preferably 3 to 9% by weight relative to the total amounts of constituents of the layer (layer B) containing voids. If the amount is less than 2% by weight, an effect of minutely dispersing the amorphous cyclic olefin copolymerized resin becomes small and a preferable particle size cannot be attained. Further, if the amount is more than 10% by weight, problems of deterioration of production stability and a cost increase arise.

Examples of inorganic particles to be used in the present invention include calcium carbonate, titanium dioxide, zinc oxide, zirconium oxide, zinc sulfide, basic lead carbonate (white lead), and barium sulfate, but among these compounds, calcium carbonate, barium sulfate, titanium dioxide, and the like, which have less absorption in a visible light region of 400 to 700 nm, are preferable from the viewpoint of a reflection property and a hiding property, production cost, and the like. In the present invention, when the calcium carbonate is employed, it is preferable to use colloidal calcium carbonate for attaining stability and a moderate dispersed particle size. Further, when the titanium dioxide is employed, it is preferable to use rutile-type titanium dioxide rather than anatase-type titanium dioxide because the rutile-type titanium dioxide has a more compact crystalline structure and therefore has a higher refractive index compared with the anatase-type titanium dioxide so that a difference in refractive index between the titanium dioxide and the polyester resin becomes large and a higher reflection action can be obtained at the interfacial surface. As for a particle size, by using particles having an average particle size on number of 0.4 to 2 μm, an excellent reflection property and an excellent hiding property can be realized. The term average particle size on number herein refers to a mean value of diameters of perfect circles obtained in the case where a cross section of a film is sliced off and particles in this cross section are observed with a SEM-XMA to determine areas of 100 particles and these particles are converted to perfect circles to having the same area. An added amount of the inorganic particles is preferably 5% by weight or more and 25% by weight or less, and more preferably 7% by weight or more and 20% by weight or less relative to the total amounts of the constituents in the layer (layer B) containing voids. If the amount is less than this range, it is not preferable because an effect of whitening degrades and a high reflection property and a high hiding property cannot be attained. Further, if the amount is more than this range, it is not preferable because a film forming property is deteriorated and there are effects of light absorption loss due to a surface treatment agent for inorganic particles.

In the present invention, by including an antioxidant in the polyester resin preferably in an amount 0.05 to 1.0% by weight, and more preferably in an amount 0.1 to 0.5% by weight relative to the total amounts of constituents in the layer B, it becomes possible to perform more stable polymer extrusion and film formation. As the antioxidant, particularly, a hindered phenol-based antioxidant and a hindered amine-based antioxidant are preferable in point of dispersibility.

In the present invention, it is preferable to dispose a thermoplastic resin layer (layer A) having a different constitution from the layer containing voids (layer B) on the outer surface of the layer B. Disposing a polyester resin which does not substantially contain the amorphous cyclic olefin copolymerized resin incompatible with polyester on at least one surface of a film having voids formed therein by a coextrusion method or the like is preferable from the viewpoint that (i) since a void-containing layer and a surface layer can be separately designed, a gloss level or a whiteness degree of the surface can be easily adjusted through the separation of functions, and (ii) film breaks during producing films can be prevented by disposing a surf ace layer having few voids and high mechanical strength. Herein, that the amorphous cyclic olefin copolymerized resin is not substantially contained means that this resin is not added intentionally, and specifically that the content of the amorphous cyclic olefin copolymerized resin is less than 1% by weight relative to the polyester resin composing this layer. By disposing such thermoplastic resin layer, it is possible to impart surface planarity and high mechanical strength to the film.

In this time, the disposed thermoplastic resin layer (layer A) may also contain organic or inorganic fine particles, and examples of the fine particles include calcium carbonate, titanium dioxide, zinc oxide, zirconium oxide, zinc sulfide, basic lead carbonate (white lead), and barium sulfate, but it is preferable to contain the same inorganic particles as in (layer B) from the viewpoint of cost, productivity and recyclability. The content of the inorganic particles in the disposed polyester resin is preferably 0.5 to 20% by weight, more preferably 1 to 18% by weight, and further particularly preferably 1 to 15% by weight relative to the total amounts of constituents of the layer A. If the content is less than 0.5% by weight, a sliding property of the film becomes low, on the other hand, if the content is more than 20% by weight, a film break may occur in film formation.

It is preferable that a light-resisting agent be contained in the layer (layer A) adjacent to the layer (layer B) containing voids inside of the white polyester film of the present invention. By containing the light-resisting agent, changes in color tone of a film due to ultraviolet light can be prevented. The light-resisting agent preferably used is not particularly limited as long as it is within the range of not impairing other properties, but it is desirable to select the light-resisting agent which has excellent heat resistance, has good chemistry with a polyester resin and can be uniformly dispersed in the polyester resin, and has less coloring and does not have harmful effects on the reflection properties of a resin and a film. Examples of such light-resisting agent include salicylate-based, benzophenone-based, benzotriazole-based, cyanoacrylate-based and triazine-based ultraviolet absorbers, and hindered amine-based ultraviolet stabilizers. Specific examples of them include salicylate-based ultraviolet absorbers such as p-t-butylphenylsalicylate and p-octylphenylsalicylate; benzophenone-based ultraviolet absorbers such as 2,4-dihydroxybenzophenone, 2-hydroxy-4-methoxybenzophenone, 2-hydroxy-4-methoxy-5-sulfobenzophenone, 2,2′,4,4′-tetrahydroxybenzophenone and bis(2-methoxy-4-hydroxy-5-benzoylphenyl)methane; benzotriazole-based ultraviolet absorbers such as 2-(2′-hydroxy-5′-methylphenyl)benzotriazole, 2-(2′-hydroxy-5′-methylphenyl)benzotriazole and 2-2′-methylenebis[4-(1,1,3,3-tetramethylbutyl)-6-(2H benzotriazole-2-yl)phenol]; cyanoacrylate-based ultraviolet absorbers such as ethyl-2-cyano-3,3′-diphenyl acrylate); and triazine-based ultraviolet absorbers such as 2-(4,6-diphenyl-1,3,5-triazine-2-yl)-5-[(hexyl)oxy]-phenol.

Further, examples of ultraviolet stabilizers include hindered amine-based ultraviolet stabilizers such as bis(2,2,6,6-tetramethyl-4-piperidyl)sebacate, polycondensation product of dimethyl succinate and 1-(2-hydroxyethyl)-4-hydroxy-2,2,6,6-tetramethylpiperidine, and others such as nickel bis(octylphenyl)sulfide and 2,4-di-t-butylphenyl-3′,5′-di-t-butyl-4′-hydroxybenzoate. Among these light-resisting agents, 2,2′,4,4′-tetrahydroxy-benzophenone, bis(2-methoxy-4-hydroxy-5-benzoylphenyl)methane, 2-2′-methylenebis[4-(1,1,3,3-tetramethylbutyl)-6-(2H benzotriazole-2-yl)phenol], and 2-(4,6-diphenyl-1,3,5-triazine-2-yl)-5-[(hexyl)oxy]-phenol, which are highly compatible with polyester, are preferably applied. The light-resisting agents may be used alone or in combination of two or more species.

The content of the light-resisting agent in the white polyester film of the present invention is preferably 0.05 to 10% by weight, more preferably 0.1 to 5% by weight, and furthermore preferably 0.15 to 3% by weight relative to a layer (layer A) containing a light-resisting agent. If the content of the light-resisting agent is less than 0.05% by weight, the light-resistance is inadequate and changes in color tone during long-term storage become large, and if the content is more than 10% by weight, it is not preferable because color tone of a film changes due to coloring by the light-resisting agent and the reflectivity may be deteriorated due to the light-resisting agent itself absorbing light.

In the present invention, it is preferable that an applied layer having an ultraviolet absorbency be provided on at least one surface since this layer can prevent the film from yellowing during long-term use. The ultraviolet absorbing layer may be a single layer or multiple layers, and when the multiple layers are used, it is desirable in point of retaining weather resistance that any one layer be a layer containing the ultraviolet absorber and preferably, two or more layers contain the ultraviolet absorber. The ultraviolet absorbing layer can be prepared by disposing a substance formed by including the ultraviolet absorber, for example, a benzophenone-based, a benzotriazole-based, a triazine-based, a cyanoacrylate-based, a salicylate-based, a benzoate-based or an inorganic ultraviolet-shielding agent in a resin component such as a thermoplastic resin, a thermosetting resin or an activate curable resin or by copolymerizing the above-mentioned ultraviolet absorber with the above-mentioned resin component. Among them, benzotriazole-based ultraviolet absorbers are more preferable.

A benzotriazole-based ultraviolet absorbing monomer is not particularly limited as long as it is a monomer which has benzotriazole as a basic skeleton and has an unsaturated double bond, but examples of preferable monomers include 2-(2′-hydroxy-5′-acryloyloxyethylphenyl)-2H-benzotriazole, 2-(2′-hydroxy-5′-methacryloxyethylphenyl)-2H-benzotriazole, and 2-(2′-hydroxy-3′-tert-butyl-5′-acryloyloxyethylphenyl)-5-chloro-2H-benzotriazole. Examples of acrylic monomer and/or oligomer to be copolymerized with these monomers include alkyl acrylate, alkyl methacrylate, and monomers having a crosslinkable functional group, for example, monomers having a carboxyl group, a methylol group, an acid anhydride group, a sulfonic acid group, an amide group, an amino group, a hydroxyl group, and an epoxy group.

In the applied layer, preferably used in the present invention, having an ultraviolet absorbency, the acrylic monomer and/or one or two or more oligomers may be copolymerized in an arbitrary ratio, but, it is preferable in point of hardness of an applied layer that methyl methacrylate or styrene be polymerized preferably in an amount of 20% by weight or more, and more preferably in an amount of 30% by weight or more relative to an acrylic monomer. As for a ratio of copolymerized between benzotriazole-based monomer and acrylic monomer, it is preferable in point of durability or adhesion to a base film that a ratio of benzotriazole-based monomer relative to sum of both monomers be 10% by weight or more and 70% by weight or less, preferably 20% by weight or more and 65% by weight or less, and more preferably 25% by weight or more and 60% by weight or less. A molecular weight of the copolymer is not particularly limited, but it is preferable from the viewpoint of the durability of the applied layer that the molecular weight be preferably 5000 or more, and more preferably 10000 or more. The preparation of the copolymer can be performed by a method such as radical polymerization, and it is not particularly limited thereto. The copolymer is disposed on the base film as an organic solvent or a water-dispersed matter, and it is particularly preferable from the viewpoint of light-resistance that its thickness be commonly 0.5 to 15 μm, preferably 1 to 10 μm, and more preferably 1 to 5 μm.

In the applied layer having an ultraviolet absorbency in the present invention, organic and/or inorganic particles may be added to the applied layer for the purpose of adjusting a gloss level of the surface. As the inorganic particles, silica, alumina, titanium dioxide, zinc oxide, barium sulfate, calcium carbonate, zeolite, kaolin, talc, and the like can be employed, and as the organic particles, silicone-based compounds, crosslinked styrene, crosslinked acryl, crosslinked melamine, and the like can be employed. The particle sizes of the organic particle and/or the inorganic particles are preferably 0.05 to 15 μm, and preferably 0.1 to 10 μm. Further, the content of the organic and/or inorganic particles is preferably 5 to 50% by weight, more preferably 6 to 30% by weight, and furthermore preferably 7 to 20% by weight relative to a dried weight of the applied layer having an ultraviolet absorbency. By specifying the particle size of the contained particles within the range, it is possible to prevent the dropout of particles and adjust the gloss level of the surface, and therefore it is preferable.

Various additives may be added to the applied layer having an ultraviolet absorbency in the present invention within the range of not impairing the effects of the present invention. As additives, for example, fluorescent brighteners, crosslinking agents, heat stabilizers, antistatic agents, and coupling agents can be used.

The applied layer having an ultraviolet absorbency may be applied by any method. The methods such as a gravure coating, roller coating, spin coating, reverse coating, bar coating, screen coating, blade coating, air knife coating, dipping and extrusion laminating may be employed, but particularly, an application method by kiss coating with a microgravure roll is preferable since it is superior in the appearance of coating and the uniformity of gloss level. When the applied layer is cured after applying, a publicly known method can be employed as a method for curing the applied layer. For example, heat curing, or methods of using active rays such as ultraviolet light, electron beams and radioactive rays, or methods of combination thereof can be applied. In the present invention, a heat curing method using a hot air oven and an ultraviolet curing method based on ultraviolet irradiation are preferable. Further, as a method for providing the applied layer, a method of applying (in line coating) concurrently with the production of a base film may be used, or a method of applying (off line coating) onto a base film in which the crystalline orientation has been completed.

In the present invention, the apparent density of the entire film is preferably 0.5 to 1 g/cm³, more preferably 0.6 to 1 g/cm³, and particularly preferably 0.7 to 1 g/cm³. If the apparent density is less than 0.5, it is not preferable because problems that film strength is low to cause film breaks and wrinkles are produced during processing in three dimensions, or a film break often occurs in a production step of a film and productivity is deteriorated arise. Further, if the apparent density is more than 1 g/cm³, since a number of voids existing in a polyester film is deficient, the reflectivity may be deteriorated. The apparent density in the present invention is a value determined by cutting a film into a sheet of 100 mm×100 mm, measuring thicknesses at 10 points in the sheet with a dial gauge to which a measuring element of 10 mm in diameter is attached, calculating a mean value d (μm) of the thicknesses, and then weighing the film with a direct reading balance and reading a weight w (g) to the fourth place of decimals.

In the white polyester film of the present invention, thermal shrinkage in case of leaving a film at 80° C. for 30 minutes is preferably 0.5% or less, more preferably 0.0 to 0.3%, and furthermore 0.0 to 0.1% both in a longitudinal direction and in a width direction. If the thermal shrinkage is more than 0.5%, it is not preferable because changes in the dimension of the film become large, and the planarity of the film is deteriorated and therefore unevenness of brightness may occur. It is preferable that the thermal shrinkage be larger than 0%. If the thermal shrinkage is less than 0.0%, that is, if the film has a tendency to extend in heating the film, it extends by heat of a cold cathode tube after the film is incorporated into a backlight unit and therefore deflection or surging easily occurs. A method of limiting the thermal shrinkage to less than 0.5% is not particularly limited, and examples of this method generally include a technique of reducing a magnifications of stretching in producing a biaxially stretched film, a technique of raising a heat-treating temperature, and a technique of applying a treatment for relaxation in a width direction and/or in a longitudinal direction concurrently with a heat treatment. In order to attain a predetermined thermal shrinkage both in a longitudinal direction and in a width direction, it is preferable to apply a treatment for relaxation also in a longitudinal direction. A method (in line treatment) in which this treatment for relaxation is performed during the production of biaxially stretched polyester film is preferable from the viewpoint of production cost, but a method (off line treatment) in which a film formed once is placed in a oven again and subjected to the treatment for relaxation may be used.

In the white polyester film of the present invention, it is preferable that the total light transmittance be less than 5.0% in order to maintain the hiding property. The total light transmittance can be limited to less than 5% by enhancing a total thickness of the film or a proper void fraction, reducing the average particle sizes on number of the amorphous cyclic olefin copolymerized resin and the inorganic particles in the film, or adjusting a ratio of the layer A to the layer B. The total light transmittance is more preferably 3.0% or less. Further, the total light transmittance is determined by measuring a polyester film according to JIS K 7105 (1981) with a haze meter (for example, HZ-2 manufactured by SUGA TEST INSTRUMENTS Co., Ltd.).

Further, it is preferable that a light reflectivity of the white polyester film of the present invention be 97% or more for attaining high brightness in incorporating the white polyester film into a backlight. The light reflectivity can be limited to 97% or more by enhancing a total thickness of the film or a proper void fraction, reducing the average particle sizes on number of the amorphous cyclic olefin copolymerized resin and the inorganic particles in the film, or adjusting a ratio of the layer A to the layer B after using the constitution of the layer B of the present invention. The light reflectivity is more preferably 99% or more, and most preferably 100% or more.

A thickness of the white polyester film of the present invention is preferably 50 to 500 μm, and more preferably 100 to 300 nm. If the thickness is less than 50 μm, it becomes difficult to secure the planarity of the film and unevenness of brightness easily occurs when it is used as a reflector. On the other hand, if the thickness is more than 500 μm, excessive thickness exceeding a thickness, which brightness performance requires, leads to increase in cost in the case where this film is used for liquid crystal display as a light reflection film. Further, a ratio of a surface layer part of the film to an inner layer part is preferably 1/200 to ⅓, and more preferably 1/50 to ¼. In the case of a three-layered constitution of surface layer part/inner layer part/surface layer part, this ratio is expressed by sum of both surface layer parts/inner layer part, but it is not necessary that a thickness of one surface layer part be equal to that of the other surface layer part and the ratio can be changed in accordance with functionality.

Next, an example of a method for producing the white polyester film of the present invention will be described, but the present invention is not limited thereto.

In the case of obtaining a film having a constitution of layer A/layer B/layer A, in a multiple film-forming apparatus having an extruder (M) and an extruder (S), first, polyester pellets having a melting point of 230 to 280° C. and master pellets of inorganic particles are mixed such that the content of the inorganic particles is 0.5 to 20% by weight and vacuum-dried well in order to form a polyester layer (layer A). An additive such as an ultraviolet absorber may be added to this dried raw material as required. Next, this dried raw material is supplied to the extruder (S) heated to 240 to 300° C. and melt-extruded, filtrated with a filter of 10 to 50 μm cut, and introduced into a T-die multiple nozzle. On the other hand, in order to form a polyester layer (layer B), vacuum-dried polyester pellets, amorphous cyclic olefin copolymerized resin incompatible with polyester, being vacuum-dried as required, master pellets of a block copolymer resin of polyalkylene glycol and a polyester resin formed from an aliphatic diol component having 2 to 6 carbon atoms and terephthalic acid, and master pellets of inorganic particles are mixed such that the content of the amorphous cyclic olefin copolymerized resin is 3 to 15% by weight, the content of the block copolymer resin of polyalkylene glycol and a polyester resin formed from an aliphatic diol component having 2 to 6 carbon atoms and terephthalic acid is 3 to 15% by weight, and the content of the inorganic particles is 10 to 30% by weight, relative to the layer B. It is preferable to use a raw material formed by melt-kneading the polyester resin, the amorphous cyclic olefin copolymerized resin, and the block copolymer resin of polyalkylene glycol and a polyester resin formed from an aliphatic diol component having 2 to 6 carbon atoms and terephthalic acid in advance with an extruder since by this way, each resin can be melt-extruded in uniform ratios to realize uniform film performance, discharge fluctuations during extrusion or fluctuations in a pressure to a filter can be prevented, and further a particle size distribution of the amorphous cyclic olefin copolymerized resin in the film can be more reduced. Furthermore, a technique, in which when the polyester resin, the amorphous cyclic olefin copolymerized resin and the block copolymer resin of polyalkylene glycol and a polyester resin formed from an aliphatic diol component having 2 to 6 carbon atoms and terephthalic acid are melt-extruded with an extruder, the amorphous cyclic olefin copolymerized resin and the block copolymer resin of polyalkylene glycol and a polyester resin formed from an aliphatic diol component having 2 to 6 carbon atoms and terephthalic acid are previously melt-kneaded in high concentrations and then this kneaded resin is diluted with the polyester resin when being supplied to the extruder in order to form a film, may also be employed. The mixed resin is supplied to the extruder (M) heated to 260 to 300° C., and melted and filtrated as in the polyester layer (layer A), and introduced into a T-die multiple nozzle. To this raw material, 1 to 10% by weight of the copolyester resin may be added as required, and furthermore a loss portion produced once in case of producing the white polyester film of the present invention may be recycled to be used as a recovered raw material. In the T-die multiple nozzle, a polymer of the extruder (M) and a polymer of the extruder (S) are layered such that the polymer of the extruder (M) becomes an intermediate layer of the layer A/layer B/layer A constitution and the polymer of the extruder (S) becomes both surface layers of the layer A/layer B/layer A constitution, and co-extruded into a sheet shape to obtain a melted sheet. A raw material prepared for forming the white polyester film of the present invention as described above is previously vacuum-dried, and thereafter it is supplied to an extruder heated to 240 to 300° C. and melt-extruded, filtrated with a sintered filter of 20 to 40 μm cut, and then introduced into a T-die nozzle to obtain a melted sheet by extrusion.

This melted sheet is brought into close contact with a drum, in which a surface temperature is cooled to 10 to 60° C., by static electricity, and cooled and solidified to prepare a non-stretched film. The non-stretched film is led to a series of rolls heated to 70 to 120° C., stretched by 3 to 4 times in a longitudinal direction (lengthwise direction, that is, traveling direction of a film) and cooled by a series of rolls of 20 to 50° C.

Subsequently, the film is led to a tenter while being grasped with clips at both ends thereof, and is stretched by 3 to 4 times in a direction orthogonal to a longitudinal direction (a width direction) in an atmosphere heated to 90 to 150° C.

Magnifications of stretching in a longitudinal direction and in a width direction are 3 to 5 times, respectively, but an area magnification (magnification of longitudinally stretching×magnification of transversely stretching) is preferable 9 to 15 times. If the area magnification is less than 9 times, a reflectivity, a hiding property or film strength of the resulting biaxially stretched film becomes inadequate, on the other hand, if the area magnification is more than 15 times, the film easily causes film break.

In order to complete the crystalline orientation of the resulting biaxially stretched film to impart planarity and dimensional stability, subsequently, heat treatment is performed at a temperature of 150 to 240° C. for 1 to 30 seconds in the tenter, and then the biaxially stretched film is slowly cooled uniformly to room temperature, and thereafter, the film is subjected to a corona discharge treatment as required in order to further enhance the adhesion property to another material, and the biaxially stretched film is wound to obtain the white polyester film of the present invention. A treatment for relaxation of 3 to 12% in a width direction or longitudinal direction may be applied as required during the step of the heat treatment.

Further, biaxial stretching may be performed successively or simultaneous biaxial stretching may be performed, but when the simultaneous biaxial stretching is performed, a film break during a production step can be prevented, or transfer defects produced by adhesion to a heating roll hardly occur. Further, after biaxial stretching, the film may be re-stretched in either a longitudinal direction or a width direction.

On the white polyester film thus obtained, the applied layer having an ultraviolet absorbency is provided by a microgravure plate or kiss coating as required, and the applied layer is dried at 80 to 140° C. and then subjected to ultraviolet irradiation to be cured. A pretreatment such as providing an adhesive layer or an antistatic layer may be applied before applying a layer having an ultraviolet absorbency.

### [Measuring Method and Evaluation Method of Properties]

Properties of the present invention were determined according the following evaluation method and evaluation criteria.

### (1) Average Particle Sizes on Number and Maximum Particle Size of Amorphous Cyclic Olefin Copolymerized Resin and Inorganic Particles

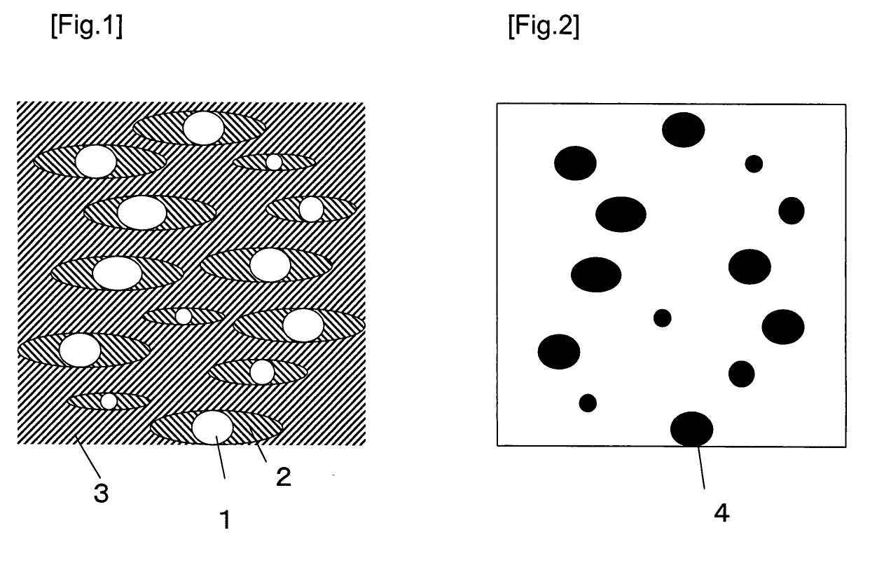

After the film was subjected to freeze treatment, a cross section of the film was sliced off along a longitudinal direction and a width direction and this cross section was magnified by 4000 times and observed with a scanning electron microscope (SEM) and a cross-sectional photograph of L-size (89 mm×127 mm) was taken (FIG. 1). This L-sized cross-sectional photograph was magnified to B4 size (257 mm×364 mm) and a copy of the photograph was made. A ready-made A4-sized overhead projection film (transparent film) was affixed to the copied image not to run out of the image, and an area on the overhead projection film corresponding to a particle area was blacked out from above the overhead projection film with a permanent marker (FIG. 2). Next, this overhead projection film was peeled off the cross-sectional image, and a copy thereof was made at the same magnification again via a plain white paper and bugs (black points) in the copy were whited out with a correction fluid. Particle images on this copy were binarized by image processing, and an area of an ellipse was determined for each particle from the major axis length and the minor axis considering a particle as an ellipse, and a each ellipse is converted to the perfect circle having the same area and a diameter of an obtained perfect circle is converted to a real diameter based on a scale in the photograph, and this real diameter is taken as a diameter of the particle. This measurement was repeated to obtain one hundred or more of particle diameters and a mean value was determined from these diameters and an average of the mean value in the cross section along a longitudinal direction and the mean value in the cross section along a width direction was taken as an average particle size on number. A maximum value of each diameter was taken as a maximum particle size.

### (2) Total Light Transmittance

A total light transmittance of a polyester film was measured with a haze meter (HZ-2 manufactured by SUGA TEST INSTRUMENTS Co., Ltd.) according to JIS K 7105 (1981), and the polyester film was rated according to the following criteria.

∘∘: Very good (The total light transmittance is less than 2.0%)

∘: Good (The total light transmittance is 2.0% or more and less than 3.0%)

Δ: Slightly bad (The total light transmittance is 3.0% or more and less than 5.0%)

x: Bad (The total light transmittance is 5.0% or more)

### (3) Light Reflectivity

A relative reflectivity in the case where an accessory device of an integrating sphere (ISR-2200 manufactured by Shimadzu Corporation) was attached to a spectrophotometer (UV-2450 manufactured by Shimadzu Corporation) and BaSO₄ was taken as a standard plate under the following conditions and the light reflectivity of the standard plate was taken as 100% was measured. At a wavelength range of 420 to 670 nm, a mean value of relative reflectivity measured every 10 nm of the wavelength was taken as an average reflectivity, and the polyester film was rated according to the following criteria.

∘∘: Very good (101% or more)

∘: Good (99% or more and less than 101%)

Δ: Slightly bad (97% or more and less than 99%)

x: Bad (less than 97%)<

### <Measuring Conditions>

Scanning speed: moderate speed

Slit: 5.0 nm

Reflection angle: 8°

### <Method for Preparing Standard Plate>

34 g of a barium sulfate white standard reagent (EASTMAN white Reflectance Standard Cat No. 6091) was put in a cylindrical recessed portion of 50.8 mm in diameter and 9.5 mm in depth, and compressed with a glass plate to prepare a barium sulfate white standard plate having a compressed density of 2 g/cm³.

### (4) Glass Transition Temperature

Using a differential scanning calorimeter (DSC-2, manufactured by Perkin Elmer Japan Co., Ltd.), 5 mg of a sample was dissolved and quenched, and then a temperature of the sample was raised again at a rate of temperature rise of 20° C./min from room temperature, and a midpoint glass transition temperature (Tmg) determined according to JIS K 7121 (1987) was adopted as a glass transition temperature.

(5) MVR (ml/10 min)

An MVR was calculated as a polymer volume discharged for 10 minutes in case of placing 2.16 kg of load at 260° C. according to ISO 1133 (2005).

### (6) Thickness of Film

Using a standard measuring element 900030 in a dial gauge No. 2109-10 manufactured by MITUTOYO Corp. and further using a dial gauge stand No. 7001 DGS-M, 5 sheets of film are laid one on top of another, and a thickness d (μm) of films in case of placing 50 g of a weight on a dial gauge holding part was measured to determine a film thickness from the following equation.

Film thickness (μm)=d/5

### (7) Ratio of Layer A to Layer B

After the film was subjected to freeze treatment, a cross section of the film was sliced off along a longitudinal direction, and this cross section was magnified by 4000 times and observed with a scanning electron microscope (SEM) S-2100A type (manufactured by Hitachi, Ltd.). A plurality of photographs of the image were taken without missing along a direction of an entire thickness so that the photographs can be joined to each other later to make one image along the entire thickness direction, and then the photographs were joined to each other to make one image along the entire thickness direction, and a length of each layer was measured from this joined photograph to determine a ratio of the layer A to the layer B.

### (8) Thermal Shrinkage

Thermal shrinkage in case of leaving a film at 80° C. for 30 minutes was measured according to ASTM D1204 (1984).

### (9) Brightness

A backlight was a straight one lamp side light type backlight (14.1 inches) to be used for a laptop computer prepared for evaluation, and the backlight, in which a film “Lumirror E60L” (film thickness 188 μm) produced by Toray Industries, Inc. was employed as a rear reflector, was used.

First, sheets such as a diffusion sheet and a prism sheet on the backlight were removed, and normal brightness of 4 sections, which were formed by dividing a backlight area into two vertically and laterally, of the backlight after a lapse of 1 hour or more from lighting in an environment maintained at 25° C. was measured with a model BM-7 manufactured by TOPCON Corp. A simple average value of measurements of brightness of 4 sections was determined to determine average brightness α0. Next, a reflector fixed to the rear reflector was removed, a sample of the formed film, which is located at the center in a width direction of the formed film, was fixed to the backlight for a evaluation, and an average brightness al was obtained as in the same manner as in α0 to evaluate according to the following equation and criteria.

Brightness(%)=100×α1/α0

### Criteria for Evaluation

∘∘: Brightness is 105% or more

∘: Brightness is 102% or more and less than 105%

Δ: Brightness is 100% or more and less than 102%

x: Brightness is less than 100%

The symbols ∘∘ and ∘ represent an acceptable level.

### (10) Stability of Film Forming

Stability of film forming was evaluated based on a number of the occurrences of the film break. The evaluation was performed by a number of the occurrences of break per one day, and rated according to the following criteria. Symbols ∘ and Δ represent an acceptable level.

∘: Good (There are few occurrences of the break (less than once/day))

Δ: Slightly bad (Sometimes, the break occurs (once or twice/day))

x: Bad (The break often occurs (twice or more/day))

xx: A film cannot be formed.

### EXAMPLES

The present invention will be described by way of the following examples, but the present invention is not limited thereto.

### A. Polyester Resin (A)

A slurry of 100 kg of high purity terephthalic acid (produced by Mitsui Chemicals, Inc.) and 45 kg of ethylene glycol (produced by NIPPON SHOKUBAI Co., Ltd.) was supplied successively to an esterification reactor over 4 hours, into which about 123 kg of bis(hydroxyethyl) terephthalate was charged in advance and which was maintained at 250° C. and at a pressure of 1.2×10⁵ Pa, and an esterification reaction was further performed over 1 hour after completing the supply of the slurry and 123 kg of this esterification reaction product was transferred to a polycondensation vessel.

Subsequently, to the polycondensation vessel to which the esterification reaction product was transferred, 0.01 kg of ethyl diethylphosphonoacetate was added, 0.04 kg of magnesium acetate tetrahydrate was further added, and an ethylene glycol solution of antimony trioxide (produced by Sumitomo Metal Mining Co., Ltd.) as a polymerization catalyst was further added such that the amount of antimony element is 0.03 g/kg relative to the weight of the resulting polyester resin.

Thereafter, a temperature of a reaction system was raised from 250° C. to 285° C. over 60 minutes and a pressure was reduced to 40 Pa while stirring a lower polymer at a rotational speed of 30 rpm. The time being elapsed before reaching an ultimate pressure was set at 60 minutes. A reaction system was purged with a nitrogen gas at the point of reaching a predetermined stirring torque and was returned to a normal pressure to stop the polycondensation reaction, and the contents of the vessel was discharged in a form of a strand into cold water of 20° C., and the discharged resin was immediately cut to obtain pellets of a polyester resin. The time being elapsed between the start of pressure reduction and reaching a predetermined stirring torque was 3 hours. The intrinsic viscosity of the obtained polyester resin was 0.65.

### B. Polyolefin-Based Resin

### (Polyolefin-Based Resin (B1))

Polymethyl pentene “TPX DX820” produced by Mitsui Chemicals, Inc. was used.

### (Amorphous Cyclic Olefin Copolymerized Resin (B2))

“TOPAS 6013” (glass transition temperature: 140° C., MVR: 14 ml/10 min), produced by Polyplastics Co., Ltd., being a copolymer of ethylene and norbornene, was used.

### (Amorphous Cyclic Olefin Copolymerized Resin (B3))

“TOPAS 6017” (glass transition temperature: 180° C., MVR: 5 ml/10 min), produced by Polyplastics Co., Ltd., being a copolymer of ethylene and norbornene, was used.

### (Amorphous Cyclic Olefin Copolymerized Resin (B4))

“TOPAS 6018” (glass transition temperature: 190° C., MVR: 4 ml/10 min), produced by Polyplastics Co., Ltd., being a copolymer of ethylene and norbornene, was used.

### C. Dispersant (C)

As the block copolymer resin of polyalkylene glycol and a polyester resin formed from an aliphatic diol component having 2 to 6 carbon atoms and terephthalic acid, “Hytrel (R) (registered trademark) 7277” produced by DU PONT-TORAY Co., Ltd., being a block copolymer of polybutyleneterephthalate (PBT) and polyalkylene glycol (PAG), was used.

### D. Copolyester Resin

### (Copolyester Resin (D1))

“Eastar Copolyester 6763” produced by Eastman Chemical Co., being formed by copolymerizing cyclohexane dimethanol or alicyclic glycol as a glycol component with polyethylene terephthalate, was used as a copolyester resin (D1).

### (Copolyester Resin (D2))

A mixture of 88 mol % of terephthalic acid and 12 mol % of ispterephthalic acid was used as an acid component and ethylene glycol was used as a glycol component, antimony trioxide was added as a polymerization catalyst such that the amount of antimony trioxide was 300 ppm on the antimony atom equivalent basis relative to the resulting polyester pellet, and the resulting mixture was subjected to a polycondensation reaction to obtain a resin having an intrinsic viscosity of 0.68, and this resin was used as a copolyester resin (D2).

### E. Light-Resisting Agent (E)

2-(4,6-diphenyl-1,3,5-triazine-2-yl)-5-[(hexyl)oxy]-phenol was used as an ultraviolet absorber.

### F. Master Pellets of Various Additives (Com 1 to Com 12)

A polyester resin (A) vacuum-dried at 160° C. for 5 hours in advance and various additives were mixed in a blending ratio by weight shown in Table 1, and the resulting mixture was supplied to a biaxial extruder heated to 280° C. to be kneaded, and the kneaded resin was discharged in a form of a strand into cold water of 20° C., and the discharged resin was immediately cut to obtain master pellets (Com 1 to Com 12).

TABLE 1
Master pellet

| | Type | | | | | Mixing ratio (percent by weight) | | | | |
|---|---|---|---|---|---|---|---|---|---|---|
| | | Polyolefin- | | | | | Polyolefin- | | | |
| | Polyester | based | | Copolyester | | Polyester | based | | Copolyester | |
| Type | resin | resin | Dispersant | resin | Others | resin | resin | Dispersant | resin | Others |
| Com1 | A | B1 | C | | | 63 | 30 | 7 | | |
| Com2 | A | B1 | C | | | 68 | 30 | 2 | | |
| Com3 | A | B2 | C | D2 | | 42 | 30 | 18 | 10 | |
| Com4 | A | B2 | C | | | 63 | 30 | 7 | | |
| Com5 | A | B3 | C | D1 | | 45 | 30 | 18 | 7 | |
| Com6 | A | E3 | C | | | 63 | 30 | 7 | | |
| Com7 | A | B4 | C | D1 | | 45 | 30 | 18 | 7 | |
| Com8 | A | | | | Barium sulfate | 50 | | | | 50 |
| | | | | | particles1) | | | | | |
| Com9 | A | | | | Calcium carbonate | 50 | | | | 50 |
| | | | | | particles2) | | | | | |
| Com10 | A | | | | Titanium dioxide | 50 | | | | 50 |
| | | | | | particles3) | | | | | |
| Com11 | A | | | | Silica particles4) | 90 | | | | 10 |
| Com12 | A | | | | light-resisting | 90 | | | | 10 |
| | | | | | agent (E) | | | | | |

1)barium sulfate particles having an average particle size of 0.5 μm
2)calcium carbonate particles having an average particle size of 1.0 μm
3)titanium dioxide particles having an average particle size of 0.3 μm
4)agglomerated silica particles having an average particle size of 3.5 μm

### Example 1

A polyester resin (A) vacuum-dried at 160° C. for 5 hours in advance, master pellets (Com 7), and master pellets (Com 9) were supplied to the extruder (M) in the proportions of 41:43:16 by weight, and a polyester resin (A) vacuum-dried at 160° C. for 5 hours in advance and master pellets (Com 9) were supplied to the extruder (S) in the proportions of 92:8 by weight, and both mixed resins were melt-extruded at 280° C. in the extruders (M) and (S), respectively, and filtrated with a filter of 30 μm cut to remove extraneous substances, and introduced into a T-die multiple nozzle. In this case, in the T-die multiple nozzle, the extruder (M) sent the resin to an inner layer of the film, and the extruder (S) sent the resin evenly to both outer layers of the film, and three resin flows were joined into one to form a three-layered structure while the respective resins were co-extruded into a sheet shape to form a melted sheet and the melted sheet was brought into close contact with a drum, in which a surface temperature was maintained at 18° C., by a static charge method, and cooled and solidified to obtain a non-stretched film. Subsequently, the non-stretched film was preheated by a series of rolls heated to 85° C. according to normal methods, stretched by 3.3 times in a longitudinal direction (lengthwise direction) with a heating roll of 90° C., and cooled by a series of rolls of 25° C. to obtain a monoaxially stretched film.

The resulting monoaxially stretched film was led to a preheating zone of 90° C. in a tenter while being grasped with clips at both ends thereof the film, and subsequently, the film was continuously stretched by 3.2 times in a direction orthogonal to a longitudinal direction (a width direction) in a heating zone of 100° C. Furthermore, the film was subjected to a heat treatment at 200° C. for 10 seconds in a heat-treating zone in the tenter, and then was subjected to a treatment for relaxation of 4 percent in a width direction at 180° C. Next, the film was slowly cooled uniformly and was wound to obtain a white polyester film. The thickness of the obtained white polyester film was 188 μm. Ratios of resins, amounts of various additives, and properties and their effects of the resulting film were as shown in Tables 2 and 3.

### Examples 2 to 3

### Comparative Examples 1 to 3, 5 to 7

A white polyester film was obtained as in Example 1 with blending ratios by weight described in tables 1 and 2. Ratios of resins, ratios of thicknesses, amounts of various additives, and properties and their effects of the resulting film were as shown in Tables 2 and 3. The thickness of the film only in Example 2 was set at 225 μm.

### Example 4

A film having a thickness of 188 μm was obtained as in Example 1 except for changing the layer constitution to the two-layered constitution of the layer A and the layer B. Ratios of resins, ratios of thicknesses, amounts of various additives, and properties and their effects of the resulting film were as shown in Tables 2 and 3.

### Example 5

A film having a thickness of 188 μm was obtained as in Example 1 except that only the extruder (M) was used and the layer constitution was changed to the single-layered constitution of the layer B. Ratios of resins, ratios of thicknesses, amounts of various additives, and properties and their effects of the resulting film were as shown in Tables 2 and 3.

### Comparative Example 4

Film formation was tried as in Example 1 with blending ratios by weight described in tables 1 and 2, but film break did not cease and a stretched film could not be obtained.

TABLE 2

| | | | | | | | | | | | | | | | Combination |
|---|---|---|---|---|---|---|---|---|---|---|---|---|---|---|---|
| | | | | | | | | | | | | Formulation of raw | | | of layer |
| | | | | | | | | | | | | material in a | | | thickness |
| | | | | Formulation of raw material in a film | | | | | | | | surface layer | | | after |
| | Raw material | | | (Upper line: type, lower line: | | | | | Raw material | | | (Upper line: type, | | | stretching |
| | supplied to an | | | blending ratio by weight) | | | | | supplied to an | | | lower line: blending | | | (layer A/layer |
| | extruder (M) | | | Poly- | | Dis- | | | extruder (S) | | | ratio by weight) | | | B/layer A) |
| | (Upper line: type, | | | este | Poly- | perse | Copoly- | Inorganic | (Upper line: type, | | | | Inor- | | or (layer B/ |
| | lower line: blending | | | [symbol] | olefin- | [symbol] | ester | particles | lower line: blending | | | | ganic p | | layer A) |
| | ratio by weight) | | | Type | Type | Type | Type | Type | ratio by weight) | | | Type | [symbol] | Others | or layer B (μm) |
| Exam- | A | Com7 | Com9 | A | B4 | C | D1 | Calcium | A | Com9 | — | A | Calcium | — | 10/168/10 |
| ple 1 | 41 | 43 | 16 | 68.4 | 12.9 | 7.7 | 3 | carbonate | 92 | 8 | | 96 | carbonate | | |
| | | | | | | | | 8 | | | | | 4 | | |
| Exam- | A | Com5 | Com8 | A | B3 | C | D1 | Barium | A | Com8 | — | A | Barium | — | 20/185/20 |
| ple 2 | 53 | 17 | 30 | 75.6 | 5.1 | 3.1 | 1.2 | sulfate | 80 | 20 | | 90 | sulfate | | |
| | | | | | | | | 15 | | | | | 10 | | |
| Exam- | A | Com3 | Com8 | A | B2 | C | D2 | Barium | A | Com8 | Com12 | A | Barium | E | 12/164/12 |
| ple 3 | 40 | 12 | 48 | 69 | 3.6 | 2.2 | 1.2 | sulfate | 60 | 20 | 20 | 84 | sulfate | 2 | |
| | | | | | | | | 24 | | | | | 14 | | |
| Exam- | A | Com5 | Com9 | A | B3 | C | D1 | Calcium | A | Com9 | — | A | Calcium | — | 150/38 |
| ple 4 | 43 | 27 | 30 | 70.1 | 8.1 | 4.9 | 1.9 | carbonate | 92 | 8 | | 96 | carbonate | | |
| | | | | | | | | 15 | | | | | 4 | | |
| Exam- | A | Com6 | Com10 | A | B2 | C | — | Titanium | — | — | — | — | — | — | 188 |
| ple 5 | 51 | 29 | 20 | 79.3 | 8.7 | 2.0 | | dioxide | | | | | | | |
| | | | | | | | | 10 | | | | | | | |
| Compar- | A | Com3 | Com8 | A | B2 | C | D2 | Barium | A | Com8 | — | A | Barium | — | 12/164/12 |
| ative | 66 | 4 | 30 | 82.7 | 1.2 | 0.7 | 0.4 | sulfate | 80 | 20 | | 90 | sulfate | | |
| Exam- | | | | | | | | 15 | | | | | 10 | | |
| ple 1 | | | | | | | | | | | | | | | |
| Compar- | A | Com4 | — | A | B2 | C | — | — | A | Com8 | — | A | Barium | — | 12/164/12 |
| ative | 57 | 43 | | 84.1 | 12.9 | 3 | | | 80 | 20 | | 90 | sulfate | | |
| Exam- | | | | | | | | | | | | | 10 | | |
| ple 2 | | | | | | | | | | | | | | | |
| Compar- | A | Com2 | Com9 | A | B1 | C | — | Calcium | A | Com9 | — | A | Calcium | — | 10/168/10 |
| ative | 40 | 50 | 10 | 79 | 15 | 1 | | carbonate | 80 | 20 | | 90 | carbonate | | |
| Exam- | | | | | | | | 5 | | | | | 10 | | |
| ple 3 | | | | | | | | | | | | | | | |
| Compar- | A | Com6 | Com8 | A | B3 | C | — | Barium | A | Com8 | — | A | Barium | — | 12/164/12 |
| ative | 6 | 34 | 60 | 57.4 | 10.2 | 2.4 | | sulfate | 80 | 20 | | 90 | sulfate | | set point |
| Exam- | | | | | | | | 30 | | | | | 10 | | |
| ple 4 | | | | | | | | | | | | | | | |
| Compar- | A | Com4 | Com8 | A | B2 | C | — | Barium | A | Com8 | — | A | Barium | — | 12/164/12 |
| ative | 24 | 66 | 10 | 70.6 | 19.8 | 4.6 | | sulfate | 80 | 20 | | 90 | sulfate | | |
| Exam- | | | | | | | | 5 | | | | | [symbol] | | |
| ple 5 | | | | | | | | | | | | | | | |
| Compar- | — | Com1 | Com11 | A | B1 | C | — | Silica | A | Com8 | — | A | Barium | — | 12/164/12 |
| ative | | 40 | 60 | 79.2 | 12 | 2.8 | | 6 | 80 | 20 | | 90 | sulfate | | |
| Exam- | | | | | | | | | | | | | 10 | | |
| ple 6 | | | | | | | | | | | | | | | |
| Compar- | A | Com5 | Com10 | A | B3 | C | D1 | Titanium | A | Com10 | — | A | Titanium | — | 10/168/10 |
| ative | 48 | 12 | 40 | 71.9 | 5.1 | 2.2 | 0.8 | dioxide | 80 | 20 | | 90 | dioxide | | |
| Exam- | | | | | | | | 20 | | | | | 10 | | |
| ple 7 | | | | | | | | | | | | | | | |

[symbol]

indicates data missing or illegible when filed

TABLE 3

| | | Structural characteristics | | | | | |
|---|---|---|---|---|---|---|---|
| | Film | | Existence of | | | | |
| | thickness | | particle having | Optical properties | | | |
| | (whole | | a maximum | Light | | | |
| | thickness) | Average | particle size of | reflection | Total light | | Stability of |
| | (μm)) | (μm) | 5 μm or more | factor | transmittance | Brightness | film forming |
| Example 1 | 188 | 1.1 | No | ∘ | ∘ | ∘ | ∘ |
| Example 2 | 225 | 0.6 | No | ∘∘ | ∘∘ | ∘∘ | ∘ |
| Example 3 | 188 | 0.5 | No | ∘ | ∘∘ | ∘ | Δ |
| Example 4 | 188 | 1.1 | No | ∘ | ∘ | ∘ | Δ |
| Example 5 | 188 | 0.4 | No | ∘ | ∘ | ∘ | Δ |
| Comparative | 188 | 0.5 | No | x | x | x | ∘ |
| Example 1 | | | | | | | |
| Comparative | 188 | 2.0 | No | Δ | Δ | Δ | ∘ |
| Example 2 | | | | | | | |
| Comparative | 188 | 1.3 | Yes | Δ | Δ | Δ | ∘ |
| Example 3 | | | | | | | |
| Comparative | — | — | — | — | — | — | xx |
| Example 4 | | | | | | | |
| Comparative | 188 | 1.6 | No | ∘ | ∘ | ∘ | x |
| Example 5 | | | | | | | |
| Comparative | 188 | 3.2 | Yes | Δ | Δ | Δ | ∘ |
| Example 6 | | | | | | | |
| Comparative | 188 | 0.2 | No | Δ | x | x | ∘ |
| Example 7 | | | | | | | |

### INDUSTRIAL APPLICABILITY

The present invention relates to a white polyester film. More particularly, the present invention relates to a white polyester film which has an excellent reflection property and an excellent hiding property, and has high productivity, and the present invention provides a white polyester film which can be suitably used for a backlight system for image display, a reflection sheet of a lamp reflector, a reflection sheet of lighting equipment, a reflection sheet for an illuminated signboard, a back-reflection sheet for a solar cell, and the like.

1. A white polyester film, wherein the white polyester film has a layer (layer B) containing voids therein, and contains amorphous cyclic olefin copolymerized resin incompatible with polyester in an amount of 3 to 15% by weight,
a block copolymer resin of polyalkylene glycol and a polyester resin formed from an aliphatic diol component having 2 to 6 carbon atoms and terephthalic acid in an amount of 2 to 10% by weight, and
inorganic particles in an amount of 5 to 25% by weight relative to the total amounts of constituents in the layer B and
wherein the average particle sizes on number of said amorphous cyclic olefin copolymerized resin and said inorganic particles dispersed in the layer B are 0.4 to 3.0 μm, respectively, and the maximum particle sizes thereof are not more than 5 μm.

2. The white polyester film according to claim 1, wherein a glass transition temperature of the amorphous cyclic olefin copolymerized resin incompatible with polyester is 120° C. or higher and 230° C. or lower.

3. The white polyester film according to claim 1, wherein a light reflectivity is 97% or more and a total light transmittance is less than 5%.

4. The white polyester film according to claim 1, wherein a copolyester resin including alicyclic glycol is contained in the layer (layer B) containing voids therein in an amount of 1 to 10% by weight relative to constituents in the layer B.

5. The white polyester film according to claim 1, wherein the amorphous cyclic olefin copolymerized resin incompatible with polyester is not substantially contained in a layer (layer A) adjacent to at least one surface of the layer (layer B) containing voids therein.

6. The white polyester film according to claim 1, wherein the same inorganic particles as in the layer B are contained in a layer (layer A) adjacent to at least one surface of the layer (layer B) containing voids therein in an amount of 0.5 to 20% by weight relative to constituents in the layer A.

7. The white polyester film for a reflection sheet according to claim 1, wherein light-resisting coating is applied to the surface layer of the white polyester film.

8. The white polyester film according to claim 1, wherein alight-resisting agent is contained in a layer (layer A) adjacent to the layer (layer B) containing voids therein in an amount of 0.05 to 10% by weight relative to constituents in the layer A.
